(19) United States
(12) Patent Application Publication
(10) Pub. No.: US 2024/0078339 A1
(43) Pub. Date: Mar. 7, 2024

(54) Anonymized videoconferencing

(71) Applicant: The Affinity Project, Inc., Cambridge, MA (US)

(72) Inventors: Ronald Steven Suskind, Cambridge, MA (US); John Nguyen, Lexington, MA (US)

(21) Appl. No.: 18/459,951

(22) Filed: Sep. 1, 2023

Related U.S. Application Data
(60) Provisional application No. 63/374,294, filed on Sep. 1, 2022.

(51) Int. Cl. G06F 21/62; G10L 25/63; H04N 7/15

(52) U.S. Cl. CPC G06F 21/6254; G10L 25/63; H04N 7/155

(57) ABSTRACT

Communications where one or more of the participants are at least partially anonymized. For example, various embodiments allow for the hiding of facial features, the distortion of voice characteristics, or both, while still allowing substantive communication.

### CROSS-REFERENCE TO RELATED APPLICATIONS

The present application claims the benefit of and priority to U.S. provisional application No. 63/374,294, filed on Sep. 1, 2023, the entire disclosure of which is hereby incorporated by reference as if set forth in its entirety herein.

### TECHNICAL FIELD

Embodiments described herein relate to methods and systems for anonymized videoconferencing.

### BACKGROUND

Much effort has been applied to the improvement of video conferencing. Improvements in hardware, software, and networking have made multi-party video conferencing a viable alternative to face-to-face meetings, especially for participants that are in different geographic locations.

However, improved frame rates and resolution and decreased latency, for example, have made state-of-the-art videoconferencing less desirable for certain applications where, e.g., anonymity or safety are prized.

Accordingly, there is a need for videoconferencing systems that are privacy preserving.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

Embodiments of the present invention allow for real-time communications where one or more of the participants are at least partially anonymized. For example, various embodiments allow for the hiding of facial features, the distortion of voice characteristics, or both, while still allowing the exchange of substantive communications.

In one aspect, embodiments relate to an anonymizing videoconferencing apparatus having a network interface configured to communicate via a network, a camera, and a computer processor configured to receive a hyperlink via the network interface, present the hyperlink to a participant, and upon receiving acceptance of the hyperlink from the participant, capture an image using the camera, locate the participant in the captured image, create an anonymized image by obscuring the participant in the captured image, record the anonymized image to a persistent storage, and transmit the anonymized image via the network interface.

In various embodiments the videoconferencing apparatus further includes a user interface, and the computer processor is further configured to receive an anonymized image via the network interface and display the received anonymized image on the user interface.

In various embodiments the computer processor is further configured to transmit the anonymized image via the network interface to a second videoconferencing apparatus comprising a user interface and configured to display the transmitted anonymized image on the user interface.

In various embodiments the videoconferencing apparatus further includes a microphone and the computer processor is further configured to capture a speech sample using the microphone, anonymize the speech sample, and transmit the anonymized sample via the network interface. In various embodiments the videoconferencing apparatus further includes a user interface and the computer processor is further configured to receive an anonymized speech sample via the network interface and present the received anonymized speech sample via the user interface. In various embodiments the computer processor is further configured to transmit the anonymized speech sample via the network interface to a second videoconferencing apparatus comprising a user interface and configured to present the transmitted anonymized speech sample via the user interface.

In various embodiments the videoconferencing apparatus further includes a user interface and the computer processor is further configured to analyze the captured image and present, via the user interface, an indication of the emotional state of the participant. In various embodiments the videoconferencing apparatus further includes a microphone and the computer processor is further configured to capture a speech sample using the microphone and determine the emotional state of the participant using the captured speech sample.

In another aspect, embodiments relate to a method for anonymized videoconferencing. The method comprising includes providing a computer processor configured to receive a hyperlink via a network interface, present the hyperlink to a participant and, upon receiving acceptance of the hyperlink from the participant, capture an image using a camera, locate the participant in the captured image, create an anonymized image by obscuring the participant in the captured image, record the anonymized image to a persistent storage, and transmit the anonymized image via a network interface configured to communicate via a network.

In various embodiments the computer processor is further configured to receive an anonymized image via the network interface and display the received anonymized image on a user interface.

In various embodiments the computer processor is further configured to transmit the anonymized image via the network interface to a second videoconferencing apparatus comprising a user interface and configured to display the transmitted anonymized image on the user interface.

In various embodiments the computer processor is further configured to capture a speech sample using a microphone, anonymize the speech sample; and transmit the anonymized sample via the network interface. In various embodiments the computer processor is further configured to receive an anonymized speech sample via the network interface; and present the received anonymized speech sample via the user interface. In various embodiments the computer processor is further configured to transmit the anonymized speech sample via the network interface to a second videoconferencing apparatus comprising a user interface and configured to present the transmitted anonymized speech sample via the user interface.

In various embodiments the computer processor is further configured to analyze the captured image and present, via a user interface, an indication of the emotional state of the participant. In various embodiments the computer processor is further configured to capture a speech sample using a microphone and determine the emotional state of the participant using the captured speech sample.

In another aspect, embodiments relate to a programmable storage device having program instructions stored thereon for causing a computer processor to perform an anonymizing videoconferencing method. The method includes receiving a hyperlink via a network interface, presenting the hyperlink to a participant and, upon receiving acceptance of the hyperlink from the participant, capturing an image using a camera, locating the participant in the captured image, creating an anonymized image by obscuring the participant in the captured image, recording the anonymized image to a persistent storage, and transmitting the anonymized image via a network interface configured to communicate via a network.

In various embodiments the method further includes receiving an anonymized image via the network interface; and displaying the received anonymized image on a user interface.

In various embodiments the method further includes capturing a speech sample using a microphone, anonymizing the speech sample, and transmitting the anonymized sample via the network interface. In various embodiments, the method further includes determining the emotional state of the participant using the captured speech sample.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified:

FIG. 1 depicts an exemplary user interface for anonymized videoconferencing;

FIG. 2 presents a block diagram of a computer system suitable for use in various embodiments;

FIG. 3 presents a block diagram of a computer system providing anonymizing videoconferencing functionality;

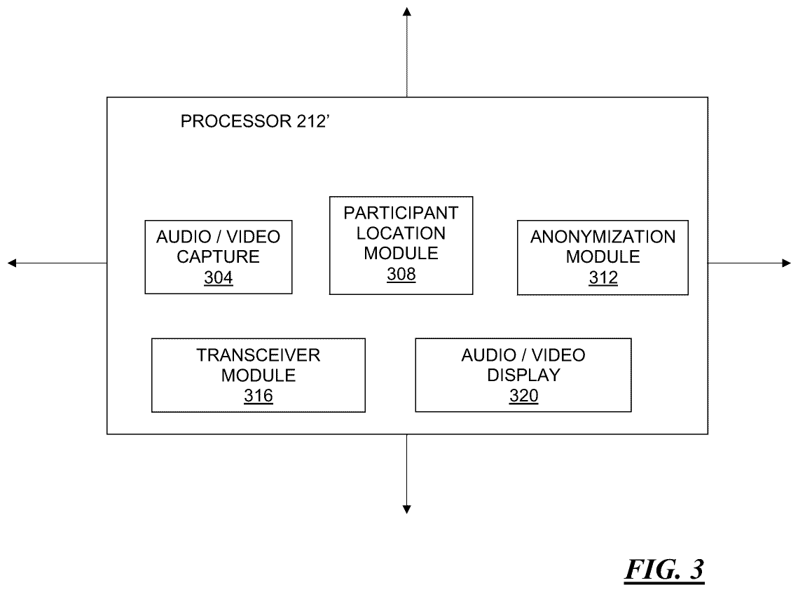

FIG. 4 presents a block diagram of a plurality of computer systems connected in a networked configuration to provide anonymized videoconferencing; and

FIG. 5 depicts a flowchart of a method for anonymized videoconferencing.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments allow for real-time communications where one or more of the participants are at least partially anonymized. For example, various embodiments allow for the hiding of facial features, the distortion of voice characteristics, or both, while still allowing the exchange of substantive communications.

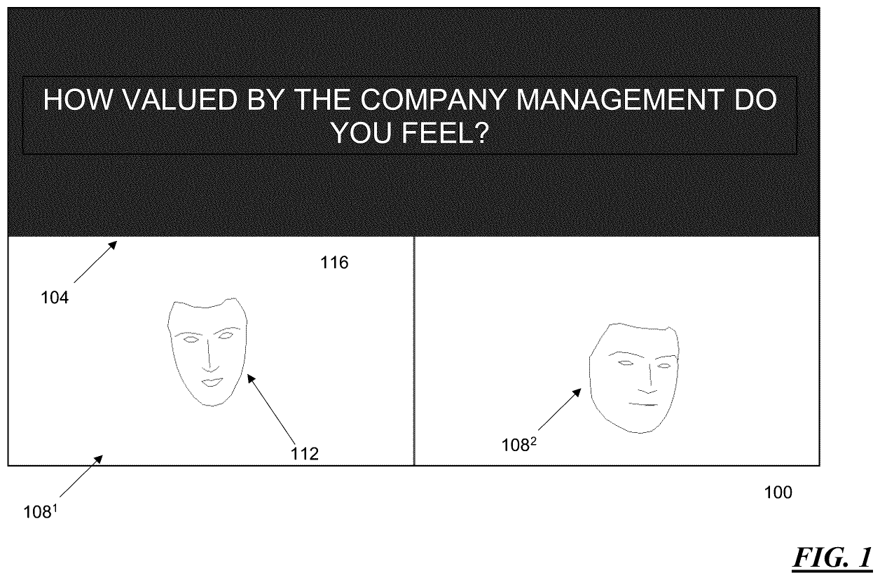

FIG. 1 presents an example of a screen 100 viewed by a user interacting with one embodiment of the invention. The screen is depicted as divided into two sections: a discussion pane 104, and participant panes 108^{N}. Each participant, e.g., the user and another individual, is associated with the contents of a participant pane 108^{N}. Although two participant panes 1081 and 1082 are shown, one of ordinary skill will recognize that it is well within the scope of the invention to have a greater number of participants and participant panes 108^{N}.

In this embodiment, the discussion pane 104 displays an item for discussion by the participants, i.e., “How valued by the company management do you feel?” In other embodiments, the discussion pane 104 is empty and blacked out or completely absent from the user interface. In some embodiments, the discussion pane 104 can be used to selectively display items for discussion: only some participants may see the item for discussion, or different participants may see different items for discussion, while other participants may see a blacked-out pane or the pane is absent in from their user interface.

Each participant pane 108^{N} displays a video feed that is divided into a participant portion 112 and a background portion 116. The participant portion 112 displays the participant, typically with some level of anonymization, and the background portion 116 displays the scene behind the participant, typically with some level of anonymization. The participant portion 112 can display the entire participant or only the participant's face, treating the participant's hair and torso as part of the background.

Various levels of anonymization may be applied to the participant portion 112. A first level of anonymization involves removing the participant entirely from the video frame, such that only the background portion 116 is displayed. A second level of anonymization replaces the image of the participant with a silhouette or outline. A third level of anonymization, shown in FIG. 1, involves the superposition of a mask over the participant's face or the complete replacement of the participant's face with the rendering of the mask. The mask may be static, i.e., unchanging, or, as discussed below, the mask may be dynamic, changing its features as the features and expressions of the participant's face change while speaking or emoting. A fourth level of anonymization blurs or otherwise distorts the image of the participant while maintaining the participant's silhouette. Another level of anonymization involves the downsampling of color in the participant's image. Multiple levels of anonymization may be employed at the same time.

Various levels of anonymization may be applied to the background portion 116 in accord with the invention. A first level of anonymization involves removing the background entirely from the video frame, such that only the participant portion 112 is displayed, which participant portion 112 itself may be subject to one or more levels of anonymization as above. A second level of anonymization replaces the background with a static image, such as a solid pane of color or a fanciful image of, e.g., a beach scene, while the participant portion 112 itself may be subject to one or more levels of anonymization as above. A third level of anonymization blurs the features of the background separate from the treatment of the participant's image, which itself may be subject to one or more levels of anonymization as above. Another level of anonymization involves the downsampling of color in the background, while the participant portion 112 itself may be subject to one or more levels of anonymization as above. Multiple levels of anonymization may be employed at the same time.

The transmission of video and images is accompanied by the transmission of audio among the parties, the audio typically being subject to some level of anonymization. For example, the pitch or the cadence of a participant's voice may be altered.

In communications among more than two participants, the audio, video, or both may be selectively anonymized. For example, participants one and three may agree to communicate without anonymization, while anonymizing each of their communications with participant two. Similarly, video may be anonymized among some or all of the participants while their audio is not anonymized or vice versa. It is also possible that the communications of each participant will be subject to different levels of anonymization with, e.g., participant one's video feed to one or more of the other participants heavily anonymized and participant two's video feed not anonymized at all.

In some embodiments, communications that may or may not be anonymized in real time may be recorded to persistent storage and/or anonymized off-line, e.g., so that viewers of the recorded communications will have difficulty identifying one or more of the individual participants. The original recordings may be kept or deleted after anonymization. Communications may be anonymized off-line prior to storage or after storage and prior to provision to a third party.

Audio and video data may be saved and processed to generate per-participant transcripts and sentiment and emotion measurements. Additional tools allow searching this data for themes (e.g., “voting preferences) or the generation of summaries and statistics from the saved data.

In some embodiments the anonymized communications begin with the sharing of an identifier this is accepted by one or more of the participants. For example, the identifier may be a uniform resource locator that, when selected, directs a client program to initiate communications with a specified computer, such as an intermediary server. The identifier may similarly be an IP address for an intermediary computer, or a pseudonymous identifier that maps to such an intermediary.

One such pseudonymous identifier can be thought of as an identifier for a virtual “room.” The virtual “room” could be created by a first user connecting to a trusted intermediary, like a server, using either a client program adapted for anonymized videoconferencing or another program, such as a web browser. After connecting to the intermediary, the first user could request a particular “room” identifier (assuming it is unique) or receive one generated, e.g., at random, by the intermediary. This identifier could, in turn, serve as a way for users to connect with each other via the intermediary or a different computer.

Having received the identifier, the first user joins the virtual “room” automatically or by entering the identifier and waits for other users to join. The first user can facilitate other users joining by sharing the identifier, e.g., via email, text message, etc., or the intermediary can similarly share the identifier, providing an additional layer of anonymity between the first user and any other user subsequently joining the “room.”

Any additional users receiving the identifier can then connect to the intermediary or a different computer specified by the identifier. The joining process may be automated or require the additional users to manually supply the identifier to their respective client programs.

The use of such an identifier permits anonymized communications between the parties, in that the use of an intermediary permits various participants to communicate with each other without knowing the identify of one or more of the other participants.

### Implementation

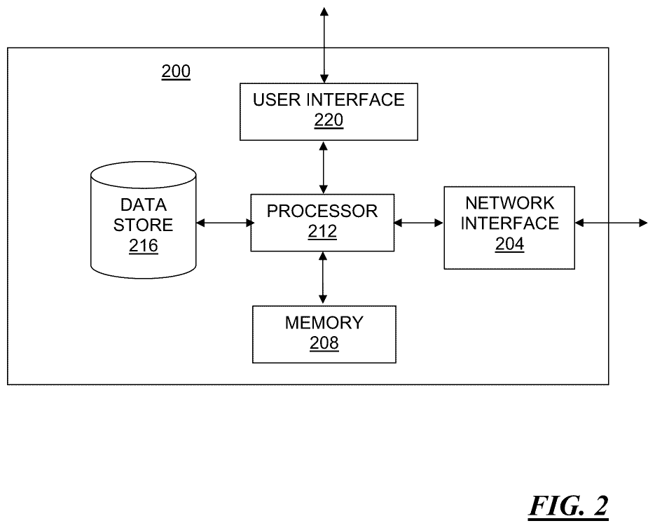

FIG. 2 depicts one example of a computer system 200 suitable for implementing various embodiments. The system 200 itself can take various forms, physical and virtual, but most implementations will share certain common functionalities.

The network interface 204 allows the system 200 to receive communications from other devices and, in one embodiment, provides a bidirectional interface to the internet. Suitable network interfaces 200 include gigabit Ethernet, Wi-Fi (802.11a/b/g/n), and 3G/4G wireless interfaces such as GSM/WCDMA/LTE that enable data transmissions between system 200 and other computerized devices.

Memory 208 serves as a store for data and computer-executable instructions that, when executed by processor 212, provide functionality in accord with the disclosure herein. Memory 208 may be used to store computer-executable instructions suitable for implementing the anonymized videoconferencing functionality discussed herein, including but not limited to instructions for capturing an image using a camera, instructions for capturing an audio frame using a microphone, instructions for applying one or more levels of anonymization to captured audio or video, instructions for transmitting and/or receiving anonymized audio and/or video via a network interface, and instructions for displaying received audio and/or video via a user interface.

Processor 212 executes the computer-executable instructions, processes stored data, and generates communications for transmission through the interface 204 and processes communications received through the interface 204 that originate outside the system 200. A typical processor 212 is an x86, x86-64, or ARMv7 processor, and the like. In accord with the present invention, the processor 212 may also execute program instructions stored in memory 208.

Data store 216 may also be used to store various data sets and program instructions. Compared to memory 208, data store 216 is often slower, but capable of storing greater quantities of information. Data store 216 provides both transient and persistent storage for data received via the interface 204, data processed by the processor 212, and data received or sent via the user interface 220. In some embodiments data store 216 is used to store audio and video communications as they are captured or in an anonymized form for later review and analysis.

User interface 220 allows the system 200 to receive commands from and provide feedback to an operator. Exemplary user interfaces include graphical displays, physical keyboards, virtual keyboards, etc. In various embodiments user interface 220 may also include audiovisual interface components such as a microphone, a camera, etc.

FIG. 300 illustrates a computer system 200 executing program instructions stored in memory 208 using processor 212 to provide various modules to offer anonymizing videoconferencing functionality. Audio/video capture module 304 captures video and/or still images using a camera and/or a microphone, as applicable. Participant location module 308 locates a participant in an image or video capture or audio sample. Anonymization module 312 applies one or more levels of anonymization to captured video, images, and/or audio, as applicable. Transceiver module 316 transmits and/or receives anonymized and/or plaintext video, images, and/or audio via a network interface. Audio/video display module 320 enables the presentation of anonymized and/or plaintext video, images, and/or audio to a user via a user interface.

In operation, audio/video data from the user interface 220 is captured using the capture module 304. Participant location module 308 locates a participant in the captured data and anonymization module 312 applies one or more levels of anonymization to the participant in the captured data. The transceiver 316 transmits the anonymized data to another similarly-configured computer system for display there to another user. Transceiver 316 may also receive anonymized data from another similarly configured computer system for display to, e.g., the original participant.

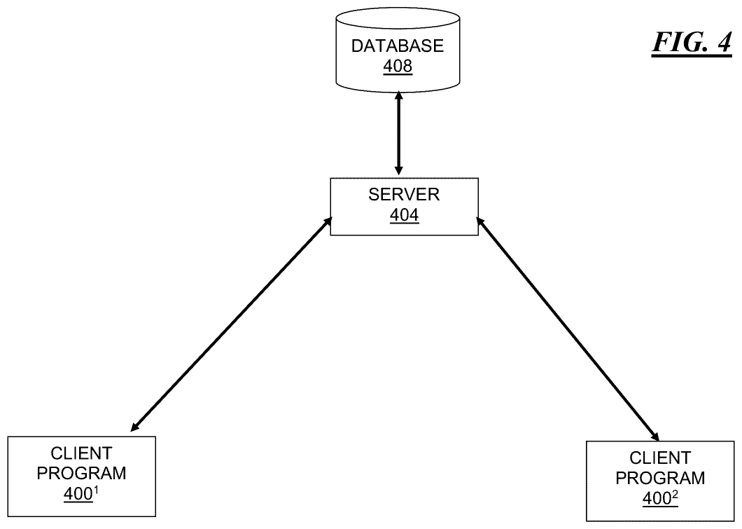

Individual computer systems 200 may be connected in a networked configuration as depicted in FIG. 4 to provide anonymized videoconferencing functionality. Each videoconferencing participant uses a client program 400^{N}, such as a web browser or a custom application executing on a computer system and written in a language such as Java or JavaScript and using publicly-available application-programming interfaces (APIs) to communicate audio and video to and from server 404, which may be operated by a third party such as TWILIO, INC. of San Francisco, California. TWILIO is a supplier of commercially-available communication tools for transmitting audio and video.

Client program 400^{N} captures audio and video using appropriate user interface devices installed on or available to the computer system executing client program 400^{N} such as a camera and/or a microphone. As discussed above, the client program 400^{N} may apply various levels of anonymity to its video and/or audio data before transmitting it to the server 404, which re-transmits the anonymized audio and video data to other client programs 400^{N}. Each client program 400^{N} may operate in a duplex mode, simultaneously transmitting and receiving anonymized video and/or audio data. Although only two client programs 400 N are depicted in FIG. 4, enabling two-way conferencing as depicted in FIG. 1, one of ordinary skill will recognize that this architecture can scale to allow for multi-party duplex communications among several client programs 400^{N}.

To apply anonymity to video data, the client program 400^{N} may capture a frame of video, apply one or more layers of anonymization to it, and then transmit the anonymized frame to the server 404 for redistribution to the other client programs 400^{N}. For example, the client program 400^{N} may use MediaPipe, offered by GOOGLE, INC., of Mountain View, California, to locate one or more faces in the frame and a plurality of 4D landmarks in each located face. In one embodiment, the plurality of landmarks can be connected in a triangle mesh and the resulting mesh can be rendered to produce a mask of the form shown in FIG. 1.

Some embodiments allow, e.g., the lighting, smoothness, and reflectivity of the mask to be adjusted to vary the appearance of the mask. Some embodiments use custom shaders to alter the darkness and hue of individual pixels based on the 4D positions of the pixel and nearby pixels to create a shiny, mirror-like, crumpled, or other effect for the mask.

Some embodiments generate a set of landmarks for a chosen image and map the landmarks in the chosen image to the landmarks in the located face, replacing the appearance of the participant with the appearance of the chosen image. This can, for example, permit the participant to emote using the face of another individual or a fictional character.

To apply anonymity to audio data, the client program 400^{N} captures a buffer full of audio data, applies one or more levels of anonymization to it, and then transmits the anonymized audio to the server 404 for redistribution to the other client programs 400^{N}. Anonymization may be achieved in some embodiments using a voice-conversion package to convert an input frame of audio into features, map those features to corresponding features in a target voice, and construct the output audio from the mapped features. Such a voice-conversion package is YourTTS, available for download at https://github.com/edresson/yourtts.

In some embodiments the transmission of the anonymized videoconferencing signals may occur directly between two individual computer systems 400^{N}, omitting server 404, and thereby permitting direct anonymized videoconferencing between two parties.

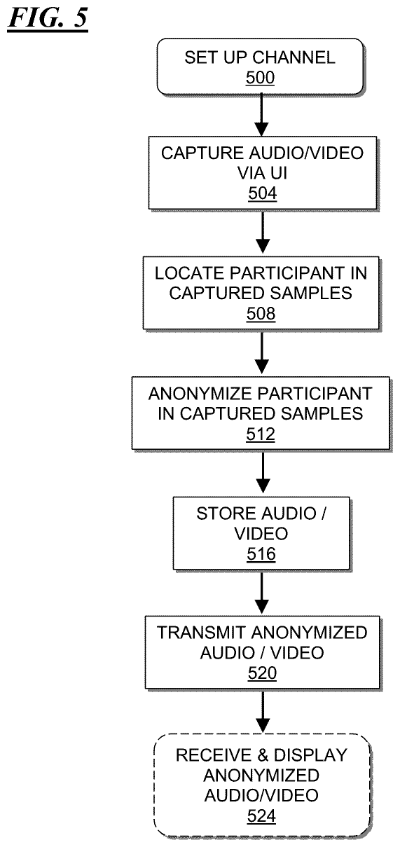

FIG. 5 is a flowchart of a method for anonymized videoconferencing. A channel for communications is established among one or more participants using, for example, an exchanged and accepted identifier (Step 500). An image is captured using a camera and/or audio is captured using a microphone (Step 504). As discussed above, a participant is located in the captured image and/or the captured audio (Step 508). The image and/or the audio, including the participant, is subjected to one or more levels of anonymization (Step 512). The original and/or anonymized audio and/or video may be stored in a persistent storage (Step 516). The anonymized image and/or audio is then transmitted via a network interface (Step 520). The computer processor may be further configured to receive an anonymized image and/or anonymized audio via the network interface and display it on a user interface (Step 524).

As discussed in FIG. 4, a plurality of client programs executing this methodology may exchange their anonymized communications via an intermediary server and thus provide systems and methods for anonymized communications.

### Applications

Various embodiments are suited to applications involving communications among two or more parties where some level of privacy is desirable.

One such example involves two participants communicating pseudo-anonymously concerning potentially threatening topics such as vaccine hesitancy. The participants can be incentivized to participate in the conversation by, e.g., giving each participant an award upon completing the conversation.

In general, embodiments can collect data on a participant's emotional state, age, gender, and race from facial features and facial images in general, audio from the participant's speech, and a text transcription of what the participant is saying.

The analysis of each participant's facial features permits the inference of the participant's emotional state. The inference of emotional state may be used to determine whether, e.g., a participant is reacting positively or negatively to the current discussion. Some embodiments may also analyze the audio tone or the words used to infer a participant's emotional state. Facial features can be analyzed to determine age and gender as well.

Processing audio using speech analysis software permits subsequent analysis to determine whether particular topics of discussion result in emotions and engender a positive or negative response in a participant. These results may be further stratified by age, gender, race, etc. Some embodiments perform this analysis in real time, giving feedback to a participant during the discussion as to whether another participant is reacting positively or negatively to the current discussion. Feedback may be presented by, e.g., shading the color of the background image in the participant's pane in the listener's window.

Some embodiments may use the results of prior analysis to present a participant with lists of topics that engender positive emotional responses in a listener, negative emotional responses, or both. The participant can then utilize topics that engender a positive emotional response while avoiding topics that engender a negative emotional response.

After each session between two or more participants is finished, the video and audio data may be archived to permanent storage. An automated process may then perform several functions. First, the audio data may be transcribed into text using speech-to-text software such as Google Speech-To-Text. This transcribed text may also be labeled by participant (i.e., participant diarization). If per-participant audio was saved, then the audio for each participant may also be transcribed separately and recombined so that the diarization results are achieved. If per-participant audio was not saved, then participant diarization may be performed with a combination of audio-based diarization and lip-movement tracking from the video frames. The text may then be analyzed to derive participant metrics such as speaking rate, average sentence length, and percent of sentences that are questions. The text may be further analyzed to assess emotion such as positive/negative sentiment or ratings on emotions such as happy, sad, angry, etc. using a mix of machine learning and heuristic measurement of word frequency.

From the saved video, audio, transcripts, diarization, and sentiment/emotion results, additional tools are available to perform analysis across one or many archived sessions. A query can be made to search for sentences that are related to a given sentence (i.e., a “theme”). Another query can be made to search for sentences that contain a set of related words, with an auxiliary tool that gives suggestions for additional related words. Another query can analyze all transcribed sentences to identify key topics along with keywords and sentences associated with those topics. For all queries, the text for each identified sentence may be returned along with a pointer to the original video and timestamps for easy retrieval of the video portion where the sentence was spoken.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims. This approach could be used in any space where there are objects that are human rated, but the set of objects remains minimally covered by human ratings. The overall concept is highly generalizable, especially in the space of security and in domains where human input is highly valued.

What is claimed is:

1. An anonymizing videoconferencing apparatus comprising:
a network interface configured to communicate via a network;
a camera; and
a computer processor configured to:
receive a hyperlink via the network interface;
present the hyperlink to a participant; and
upon receiving acceptance of the hyperlink from the participant:
capture an image using the camera;
locate the participant in the captured image;
create an anonymized image by obscuring the participant in the captured image;
record the anonymized image to a persistent storage; and
transmit the anonymized image via the network interface.

2. The videoconferencing apparatus of claim 1 further comprising a user interface, and wherein the computer processor is further configured to receive an anonymized image via the network interface; and display the received anonymized image on the user interface.

3. The videoconferencing apparatus of claim 1 wherein the computer processor is further configured to transmit the anonymized image via the network interface to a second videoconferencing apparatus comprising a user interface and configured to display the transmitted anonymized image on the user interface.

4. The videoconferencing apparatus of claim 1 further comprising a microphone, and wherein the computer processor is further configured to:
capture a speech sample using the microphone;
anonymize the speech sample; and
transmit the anonymized sample via the network interface.

5. The videoconferencing apparatus of claim 4 further comprising a user interface, and wherein the computer processor is further configured to receive an anonymized speech sample via the network interface; and present the received anonymized speech sample via the user interface.

6. The videoconferencing apparatus of claim 4 wherein the computer processor is further configured to transmit the anonymized speech sample via the network interface to a second videoconferencing apparatus comprising a user interface and configured to present the transmitted anonymized speech sample via the user interface.

7. The videoconferencing apparatus of claim 1 further comprising a user interface, and wherein the computer processor is further configured to analyze the captured image and present, via the user interface, an indication of the emotional state of the participant.

8. The videoconferencing apparatus of claim 7 further comprising a microphone, and wherein the computer processor is further configured to:
capture a speech sample using the microphone; and
determine the emotional state of the participant using the captured speech sample.

9. A method for anonymized videoconferencing, the method comprising:
providing a computer processor configured to:
receive a hyperlink via a network interface;
present the hyperlink to a participant; and
upon receiving acceptance of the hyperlink from the participant:
capture an image using a camera;
locate the participant in the captured image;
create an anonymized image by obscuring the participant in the captured image;
record the anonymized image to a persistent storage; and
transmit the anonymized image via a network interface configured to communicate via a network.

10. The method of claim 9 wherein the computer processor is further configured to receive an anonymized image via the network interface; and display the received anonymized image on a user interface.

11. The method of claim 9 wherein the computer processor is further configured to transmit the anonymized image via the network interface to a second videoconferencing apparatus comprising a user interface and configured to display the transmitted anonymized image on the user interface.

12. The method of claim 9 wherein the computer processor is further configured to:
capture a speech sample using a microphone;
anonymize the speech sample; and
transmit the anonymized sample via the network interface.

13. The method of claim 12 wherein the computer processor is further configured to receive an anonymized speech sample via the network interface; and present the received anonymized speech sample via the user interface.

14. The method of claim 12 wherein the computer processor is further configured to transmit the anonymized speech sample via the network interface to a second videoconferencing apparatus comprising a user interface and configured to present the transmitted anonymized speech sample via the user interface.

15. The method of claim 9 wherein the computer processor is further configured to analyze the captured image and present, via a user interface, an indication of the emotional state of the participant.

16. The method of claim 15 wherein the computer processor is further configured to:
capture a speech sample using a microphone; and
determine the emotional state of the participant using the captured speech sample.

17. A programmable storage device having program instructions stored thereon for causing a computer processor to perform an anonymizing videoconferencing method, the method comprising:
receive a hyperlink via a network interface;
present the hyperlink to a participant; and
upon receiving acceptance of the hyperlink from the participant:
capture an image using a camera;
locate the participant in the captured image;
creating an anonymized image by obscuring the participant in the captured image;
record the anonymized image to a persistent storage; and
transmitting the anonymized image via a network interface configured to communicate via a network.

18. The programmable storage device of claim 17 wherein the method further comprises receiving an anonymized image via the network interface; and displaying the received anonymized image on a user interface.

19. The programmable storage device of claim 17 wherein the method further comprises:
capturing a speech sample using a microphone;
anonymizing the speech sample; and
transmitting the anonymized sample via the network interface.

20. The programmable storage device of claim 19 wherein the method further comprises determining the emotional state of the participant using the captured speech sample.
